(19) United States
(12) Patent Application Publication
(10) Pub. No.: US 2009/0299829 A1
(43) Pub. Date: Dec. 3, 2009

(54) SYSTEM AND METHOD FOR JOB PLACEMENT

(76) Inventors: Donald K. Fraser, Ira Township, MI (US); Eric Myers, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/437,932

(22) Filed: May 8, 2009

Related U.S. Application Data
(60) Provisional application No. 61/051,511, filed on May 8, 2008.
(60) Provisional application No. 61/074,396, filed on Jun. 20, 2008.

(51) Int. Cl. G06Q 10/00; G06Q 50/00; G06F 17/30

(52) U.S. Cl. 705/11; 705/7; 707/104.1; 707/3; 707/E17.044; 707/E17.108

(57) ABSTRACT

A computer-implemented method of recording employment history of a job seeker includes receiving at least one employment experience selection from a job seeker. A plurality of skills related to the at least one employment experience selection are presented to the job seeker over a network. The job seeker is asked to provide a time period corresponding to an amount of time that the job seeker has used a selected skill. The job seeker is also asked to select one of a plurality of predefined competency ratings for the selected skill. A time period and competency rating for the selected skill is received. A freeform text entry field is provided for the job seeker to provide information about how the job seeker has performed a selected task. A description of how the job seeker has performed the selected task is received over the network from the freeform text entry field. The at least one employment experience selection, the selected skill and related skill data received from the job seeker, and the selected task and related task data received from the job seeker are stored in a database on the server.

The application claims priority to U.S. Provisional Application No. 61/051,511 which was filed on May 8, 2008. This application also claims priority to U.S. Provisional Application No. 61/074,396 which was filed on Jun. 20, 2008.

### BACKGROUND OF THE INVENTION

This application relates to job placement, and more specifically to a computer-implemented interactive job placement system operable to perform a variety of job placement functions.

Websites exist in which an employer seeking employees may post a job, individuals seeking employment may post pre-existing resumes, and recruiters looking for candidates for a particular job may search the resumes. In these systems, a job seeker creates a resume outside of the system, and uploads the pre-existing resume without modification. Resume searches are conducted using Boolean logic to find relevant candidates. However, due to the great variation in resume terminology and verbage and the subjective nature of job titles, keyword searches often yield a large number of candidates, many of whom may be only marginally qualified.

### SUMMARY OF THE INVENTION

A computer-implemented method of recording employment history of a job seeker includes receiving at least one employment experience selection from a job seeker. A plurality of skills related to the at least one employment experience selection are presented to the job seeker over a network. The job seeker is asked to provide a time period corresponding to an amount of time that the job seeker has used a selected skill. The job seeker is also asked to select one of a plurality of predefined competency ratings for the selected skill. A time period and competency rating for the selected skill is received. A freeform text entry field is provided for the job seeker to provide information about how the job seeker has performed a selected task. A description of how the job seeker has performed the selected task is received over the network from the freeform text entry field. The at least one employment experience selection, the selected skill and related skill data received from the job seeker, and the selected task and related task data received from the job seeker are stored in a database on the server.

A computer-implemented method of recording a job description includes receiving at least one employment experience selection from an employer, and presenting to the employer over a network a plurality of skills and tasks related to the at least one employment experience selection. The employer is asked to provide a time period corresponding to an amount of time that that the employer wishes a job seeker to have used a selected skill. The employer is also asked to select one of a plurality of predefined competency ratings corresponding to a competency that the employer wishes a job seeker to have for the selected skill. A time period and competency rating for the selected skill is received. A freeform text entry field is provided for the employer to provide information about a selected task the employer wishes a job seeker to have performed. A description is received over the network from the freeform text entry field of the task that the employer wishes a job seeker to have performed. The at least one employment experience selection, the selected skill and related skill data received from the employer, and the selected task and related task data received from the employer are stored in a database on a server as a job description.

A computer-implemented method of dynamically generating a resume stores employment experience data received over a network from a job seeker. A job description having a plurality of associated job characteristics is transmitted to the job seeker. A menu in which the job seeker can select or deselect the employment experience data is provided. A selection of employment experience data identified as being relevant to the job characteristics is received. A resume is dynamically generated on a server in response to the selection of employment experience data.

A computer-implemented method of performing a job placement includes receiving a job description from an employer. The job description corresponds to a job for which the employer is seeking an employee, and is received on a server over a network. A plurality of searchable job seeker tasks and skills are presented. A selection of desired tasks and skills corresponding to the job description are received. A database of job seeker employment experience data is searched in response to the selection of desired tasks and skills. A resume of at least one job seeker is provided in response to the selection of desired tasks and skills. The resume is transmitted to the employer. The job description may be received and the resume may be transmitted prior to the job description being formerly approved by a manager at the employer.

A computer-implemented method of approving compensation for a job placement includes matching a job seeker out of a database of job seekers with a job description out of a database of job descriptions, wherein the job description is associated with an employer. Confirmation of a job placement between a job seeker and an employer is received. An invoice for a job placement fee is transmitted to the employer. Payment of a first portion of the job placement fee to the job seeker is approved. Payment of a second portion of the job placement fee to an individual is approved in response to the individual having invited the job seeker to the job placement system.

A computer-implemented job placement system includes a computer including memory and a processor. The computer is programmed to receive information relating to job descriptions and job seekers. An employment database stored in the memory includes at least one the job description corresponding to a job for which an employer is seeking an employee, an employment experience selection from a job seeker, an explanation of how a job seeker has performed at least one task and at least one skill associated with the employment experience selection, at least one competency rating indicating the job seeker's level of expertise for the at least one skill, and at least one duration of experience indicating a duration of time the job seeker has possessed the at least one skill. The system also includes a resume software module operable to dynamically generate a resume on the server in response to the employment experience data, at least one explanation, at least one competency rating, and at least one duration of experience.

These and other features of the present invention can be best understood from the following specification and drawings, the following of which is a brief description.

### BRIEF DESCRIPTION OF THE DRAWINGS

FIG. 1 schematically illustrates a computer-implemented job placement system.

FIG. 1a schematically illustrates a database including a plurality of job seeker profiles and job descriptions.

FIG. 2a schematically illustrates a first configuration for the system of FIG. 1.

FIG. 2b schematically illustrates a second configuration for the system of FIG. 1.

FIG. 3 schematically illustrates a computer-implemented method of recording employment history of a job seeker.

FIG. 4 schematically illustrates a computer-implemented method of dynamically generating a resume.

FIG. 5 schematically illustrates a computer-implemented method of performing a job placement.

FIG. 6 schematically illustrates a a computer-implemented method of approving compensation for a job placement.

FIG. 7 illustrates an example employment experience selection screen.

FIG. 8a illustrates an example presentation of tasks and skills.

FIG. 8b illustrate the presentation of FIG. 8a after selection of a task and a skill.

FIG. 9a illustrates a first example job description creation screen.

FIG. 9b illustrates a second example job description creation screen.

FIG. 10 illustrates an example job description.

FIG. 11a illustrates a first example resume creation screen.

FIG. 11b illustrates a second example resume creation screen.

FIG. 12a illustrates an example resume corresponding to the resume creation screen of FIG. 11a.

FIG. 12b illustrates an example resume corresponding to the resume creation screen of FIG. 11b.

FIG. 13 illustrates an example job offer screen.

FIG. 14 illustrates an example job hire confirmation screen.

FIG. 15 illustrates an example employee discharge screen.

FIG. 16 illustrates an example job seeker profile viewable by recruiters.

FIG. 17a illustrates a first example job seeker home screen.

FIG. 17b illustrates a second example job seeker home screen.

FIG. 18 illustrates an example employer home screen.

FIG. 19 illustrates an example recruiter home screen.

FIG. 20 illustrates an example resume activity screen.

FIG. 21 illustrates an example resume transmission screen.

### DETAILED DESCRIPTION OF THE PREFERRED EMBODIMENT

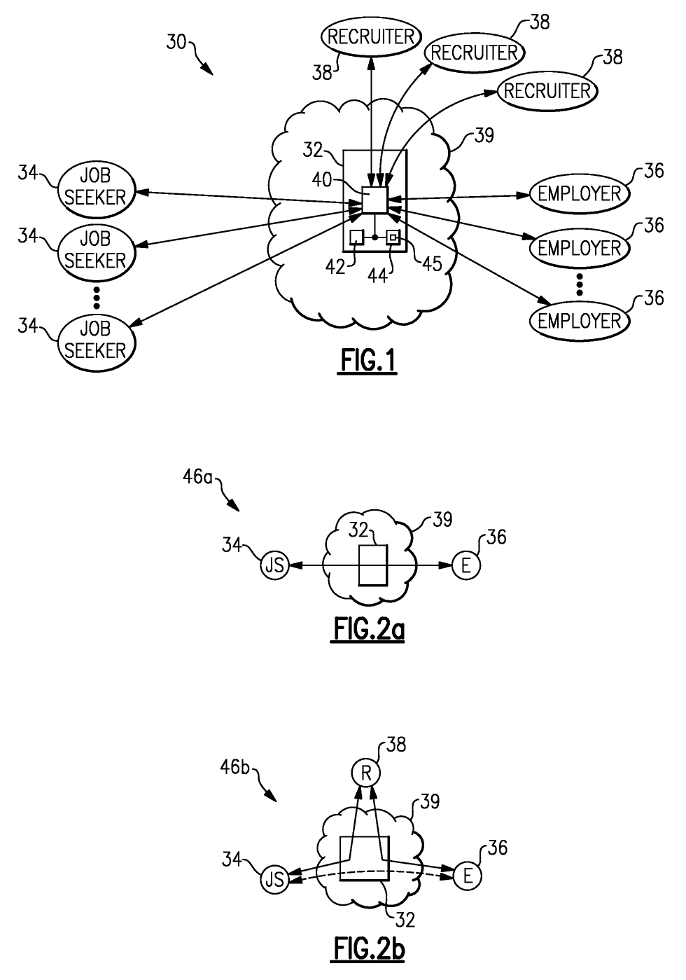

FIG. 1 schematically illustrates a computer-implemented job placement system 30. The system includes a server 32 programmed to communicate with job seekers 34, employers 36, and (optionally) recruiters 38 over a network 39. The server includes an input/output (“IO”) device 40, a microprocessor 42, and storage 44. The storage 44 could include memory, hard drives, or any electronic, optical, magnetic or other type of computer storage. A database 45 is stored in the storage 44. The server is operable to communicate with the job seekers 34, employers 36, and recruiters 38 over a network 39, such as the Internet. Of course, other networks 39 could be used. Also, multiple networks 39 could be used. Also, although only a single server 32 is illustrated, the term “server” should be interpreted broadly to include one or more servers, virtual servers, clustered servers, redundant servers, etc. In one example the network 39 could be the World Wide Web (“WWW”), and the parties 34, 36, 38 access the system 30 using computers, terminals, and/or web browsers.

The server 32 is operable to receive employment data from job seekers 34, and is operable to receive job descriptions from employers 36. Recruiters 38 or employers 36 can use the system 30 to identify job seekers 34 qualified for the employer job descriptions. Also, job seekers 34 can use the system 30 to identify job descriptions for which they are qualified without the assistance of a recruiter. The system 30 can be used to initiate job offers, job offer acceptances, job offer rejections, and job offer negotiations, for example. Additionally, the system can be used to approve compensation for a job seeker once the job seeker obtains employment through the system 30. In one example, if a first job seeker invites a second job seeker to the system 30, both the first job seeker and the second job seeker will be compensated when the second job seeker obtains employment through the system 30 through a referrer/invitee configuration.

FIG. 1a schematically illustrates a database 45 including a plurality of job seeker profiles 20a-c and job descriptions 22a-c. As shown in FIG. 1a, the job seeker profiles 20 store data related to a job seeker, such as experience, education, tasks performed, skills possessed, upcoming interviews, etc. The job descriptions 22 store information related to job descriptions for open jobs, such as job duties, required skills, optional skills, salary, etc.

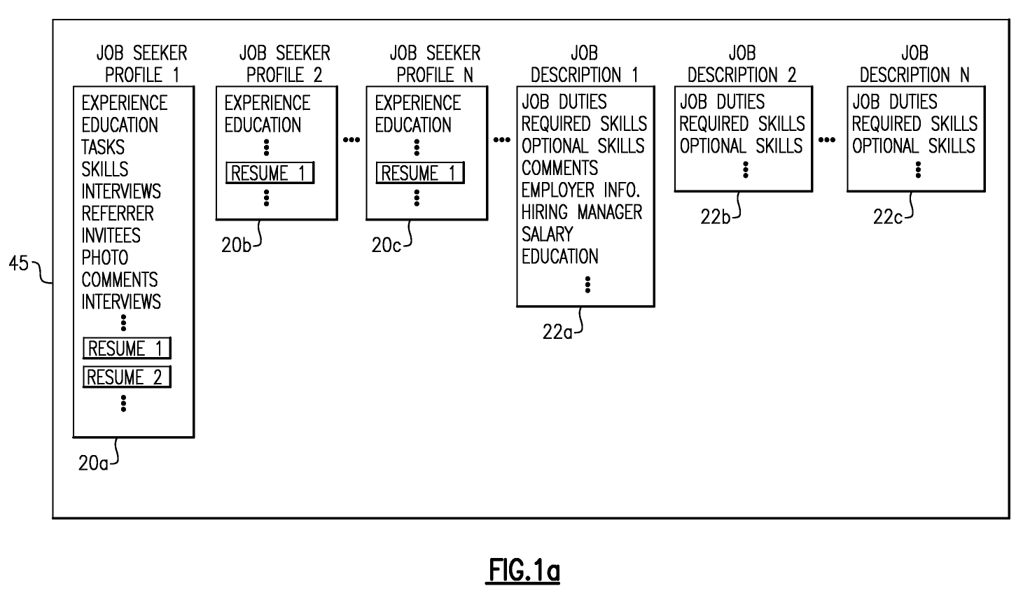

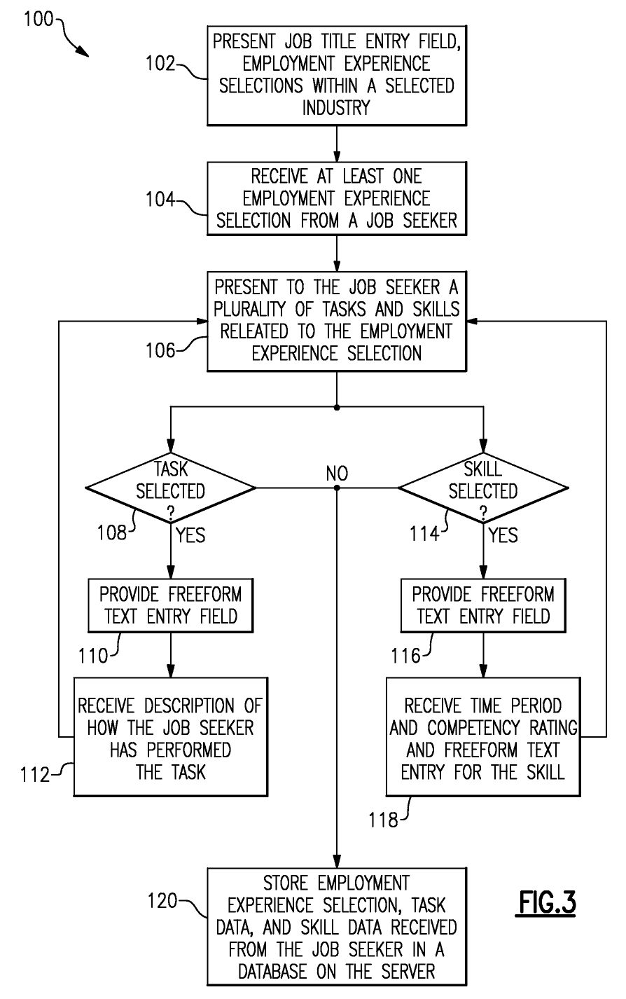

FIG. 2a schematically illustrates a first configuration 46a for the system 30, in which job seekers 34 communicate directly with employers 36 through the system 30. FIG. 2b schematically illustrates a second configuration 46b for the system 30, in which recruiters 38 act as intermediaries between the job seekers 34 and employers 36. The configuration of FIG. 2b can correspond to a vendor-managed system or “VMS” in which, for example, a specific recruiting firm works on behalf of a specific employer to find qualified individuals to fill jobs. Note that in the VMS configuration 46b, job seekers 34 may also optionally be permitted to communicate with employers 36 (see dotted line). Thus, the system 46b forms a triangular system of communication between job seekers 34, employers 36, and recruiters 38. It can also provide an effective way for employers 36 and job seekers 34 to connect without intervention by recruiters 38 (see FIG. 2a, or the dotted line of FIG. 2b).

The system 30 may be used to perform many functions relating to job placement, as will be described below.

Recording Employment History of Job Seeker

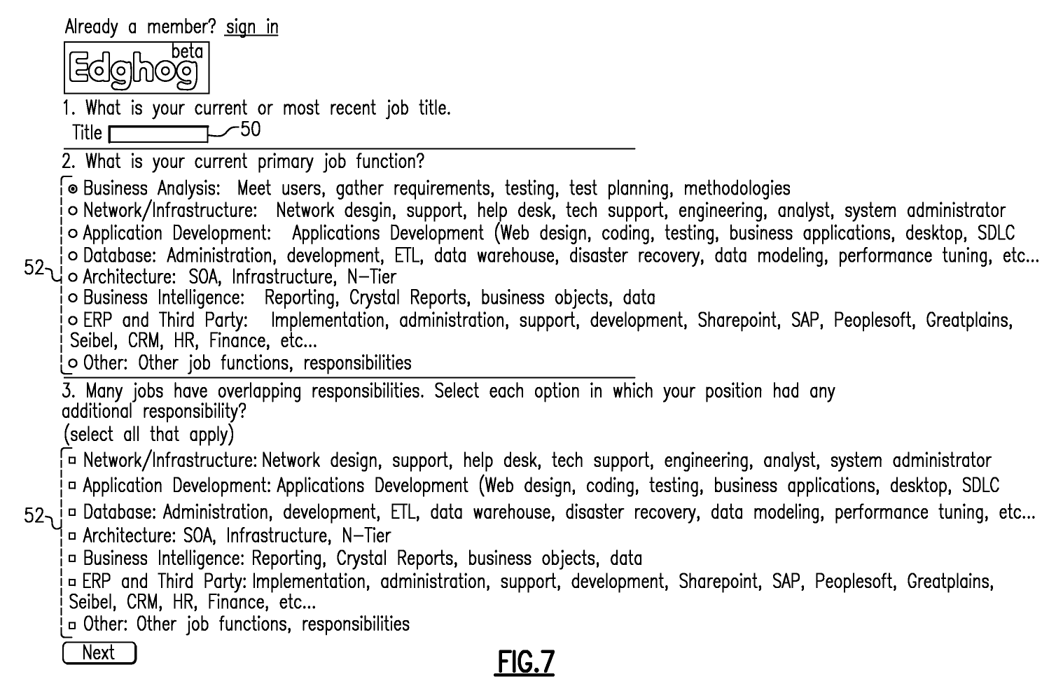

FIG. 3 schematically illustrates a computer-implemented method 100 of recording employment history of a job seeker. The system 30 presents a field 50 for a job seeker 34 to enter a current (or previous) job title, and also presents multiple employment experience selections 52 within a selected industry (step 102) (see FIG. 7). For example, if the industry is “Information Technology” the employment experience selections could include “Business Analysis,” “Network/Infrastructure”, “Application Development”, etc. As shown in FIG. 7, multiple employment experience selections can be made.

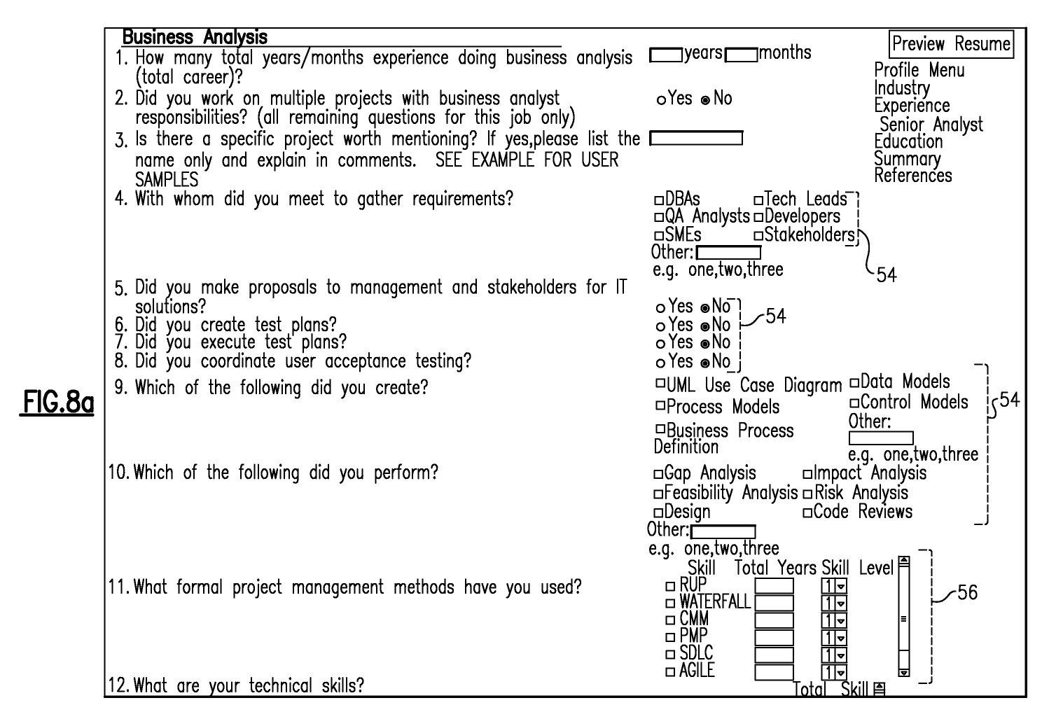

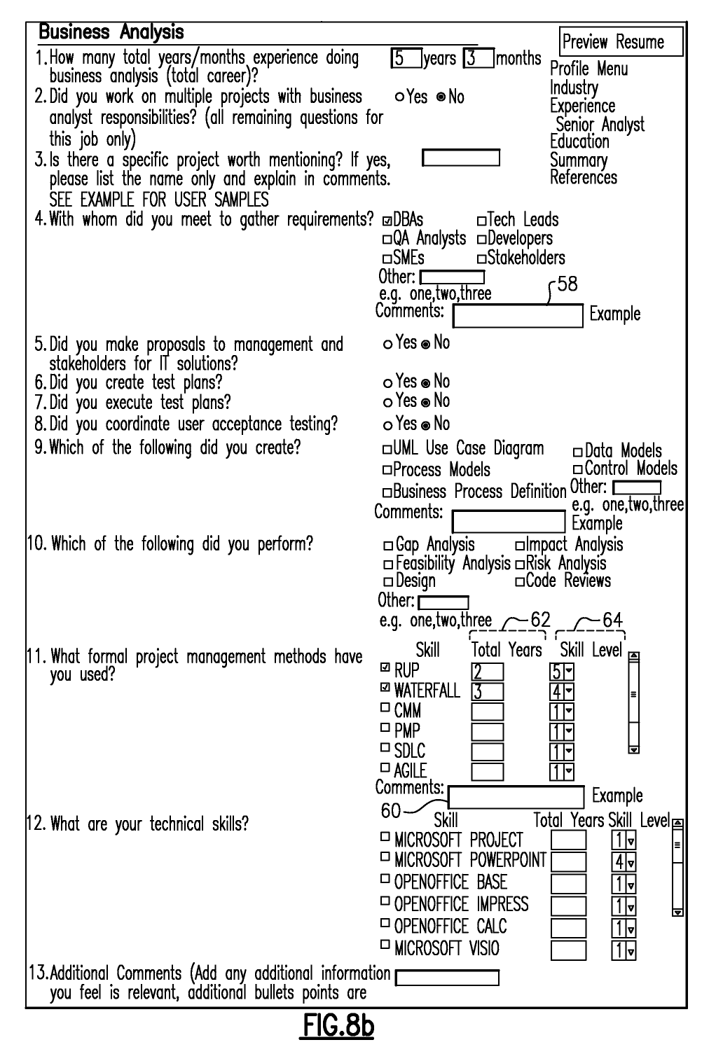

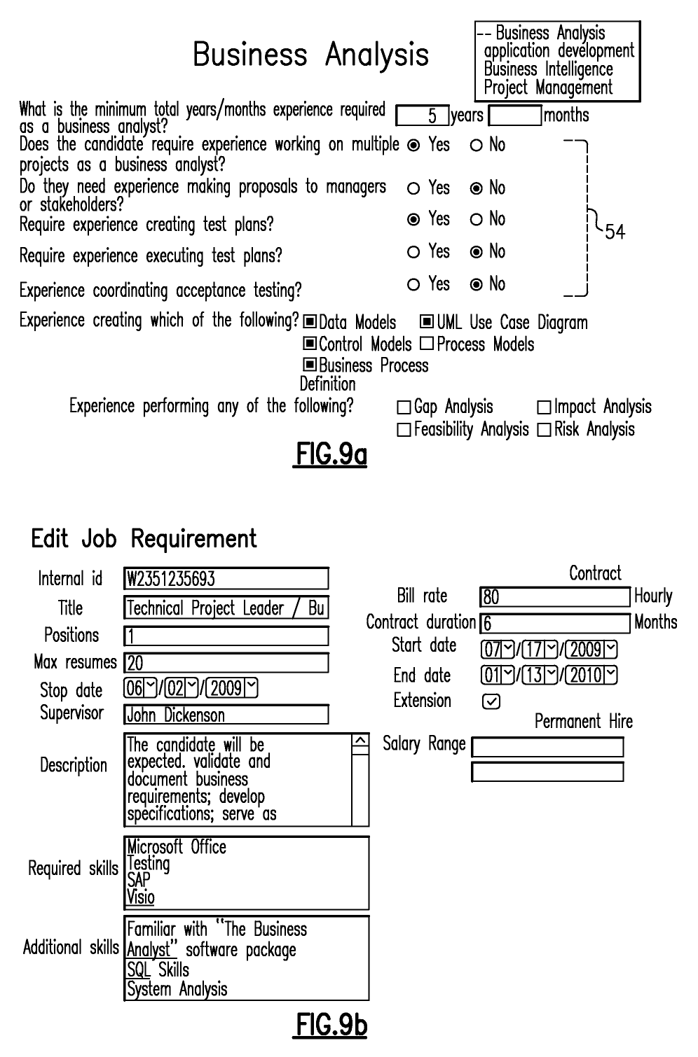

At least one employment experience selection 52 is received from the job seeker (step 104). The job seeker is then presented with a plurality of tasks 54 and skills 56 related to the employment experience selection (step 106) (see FIGS. 8-9). Tasks 54 refer to items that a job seeker 34 has performed (e.g. making proposals to management and stakeholders for IT solutions, creating test plans, executing test plans, etc.). Skills 56 refer to abilities that a job seeker 34 is able to perform (e.g. use RUP, use WATERFALL, use CMM, etc.).

Referring to FIG. 3, and using “Business Analysis” as an example employment experience selection 52, the job seeker 34 is provided with a plurality of tasks 54 and skills 56 related to Business Analysis. If the job seeker selects a task (step 108), such as “DBAs”, then a freeform text entry field 58 is presented (step 110) (see FIG. 8b), in which the job seeker has the option of elaborating on the selected task (step 112). In one example the freeform entry field 58 is provided (step 308) in response to the task selection (step 306). However, it is also possible that the freeform entry field 58 could be present without selection. The user can click the link entitled “Example” next to the freeform entry field 58 to view an example (possibly in a new window) of how a job seeker might elaborate on the selected task. Although the job seeker 34 may not be explicitly asked to provide a time period corresponding to how long a task was performed, the system 30 can infer from a duration of a job how long the task was performed (e.g. because job seeker worked at job from 2000-2002, a selected task was performed for approximately 2 years).

If the job seeker selects a skill (step 114), for example “RUP”, a freeform text entry field 60 is provided (step 116). In one example the freeform entry field 60 is provided (step 314) in response to the skill selection (step 312). However, it is also possible that the freeform entry field 60 could be present without selection. The job seeker is also asked to provide a time period 62 that the job seeker has had the skill and a competency rating 64 (see FIG. 8b). The information 60-64 is received (step 118). The task steps 108-112 and skill steps 114-118 can be selectively repeated for each task or skill a job seeker wishes to include in their employment experience data. Also, other job seeker information could be received (e.g. educational information, a summary, an objective, awards received, etc.). The employment experience data is stored in the database 45 in the storage 44 on the server 32 (step 120).

The job seeker may then search for and view job descriptions for open jobs. In one example the job descriptions come from employers 36 who have transmitted their job descriptions to the server 32. In one example the job descriptions come from employers who have transmitted their job descriptions to third party websites (e.g. indeed.com, monster.com, careerbuilder.com, linkedin.com, etc.).

The skills 54 and tasks 56 can be carefully crafted to represent a spectrum of possible skills and tasks associated with a job. Because some job titles (e.g. “Systems Analyst”) can be very open-ended and can mean many different things, the use of preformatted phrases for tasks and skills helps to accurately record employment experience data for a job seeker.

Job Description Generation

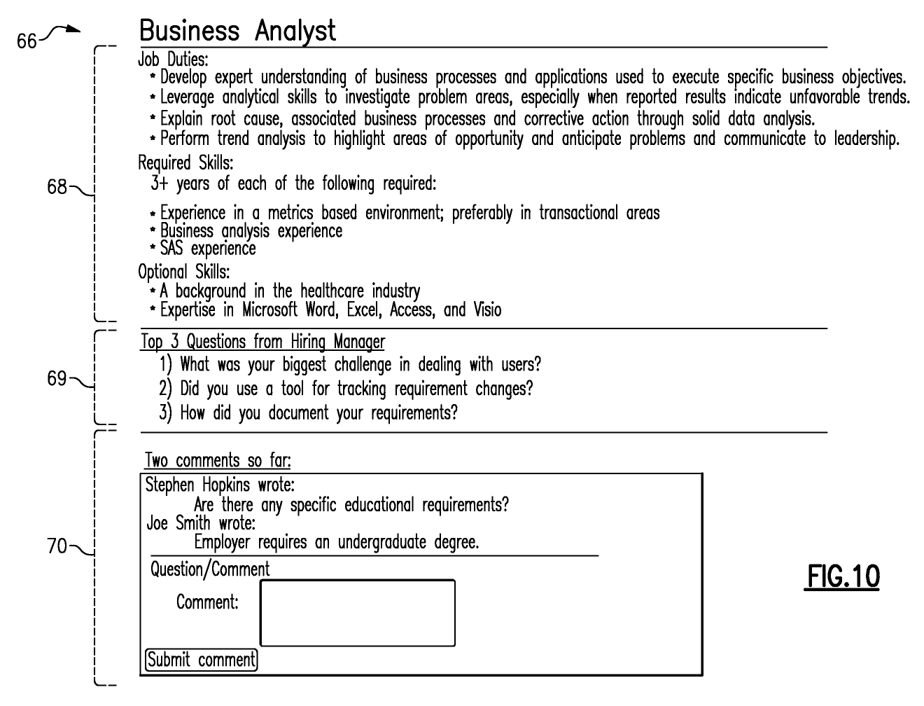

Just as a job seeker 34 enters employment experience data in response to a plurality of menu options illustrating tasks 54 and skills 56 (see FIG. 8a) using the method 100 of FIG. 3, an employer 36 could similarly create job descriptions 66 (see FIG. 10) by entering associated job characteristics 68 in a similar fashion. For example, the employer 36 could select an area of employment (step 102) (see FIG. 7), and could be presented with a plurality of tasks 54, skills 56, and other attributes (e.g. education) (steps 104-106) (see FIG. 9a). Steps 108-120 could be performed to store the job description characteristics 68, and then a job description 66 could be dynamically generated (see, e.g. step 210).

Also, if the employer 36 did not wish to use the interview-style wizard shown in FIG. 9a, the employer 36 could choose to manually enter a job description, as shown in FIG. 9b. In one example the employer 36 would be able to designate tasks 54 and skills 56 as either “required” or “optional” (see “Required skills” text box).

The creation of a job description 66 could also include receiving interview questions 69 from the employer 36 (see FIG. 10). Of course, the interview questions 69 could also be received, for example, by a recruiter 38 who is in communication with the employer 36. In one example the employer 36 could provide audio recordings, or audio/video recordings of the questions

Resume Generation

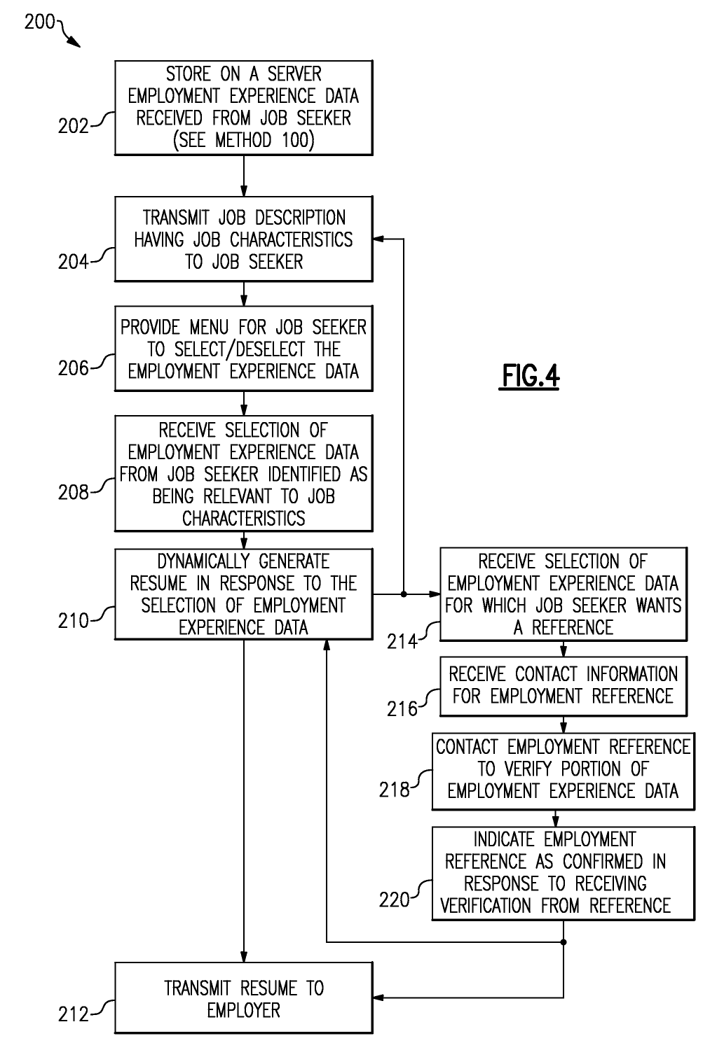

FIG. 4 schematically illustrates a computer-implemented method 200 of dynamically generating a resume from a job seeker's employment experience data. Employment experience data is stored on a server (step 202). This employment experience data could correspond to the data recorded in the method 100 of FIG. 3, for example. A job description 66 (see, e.g., FIG. 10) is transmitted to the job seeker 34 (step 204). As shown in FIG. 10, the job description 66 includes multiple job characteristics 68 (e.g. job duties, required skills, optional skills, etc.), questions 69 from a hiring manager (of employer 36), and a comment area 70. In one example the questions 69 and comment area 70 are only present in the VMS configuration (see FIG. 2b) and are only visible to recruiters 38 with access to the VMS system.

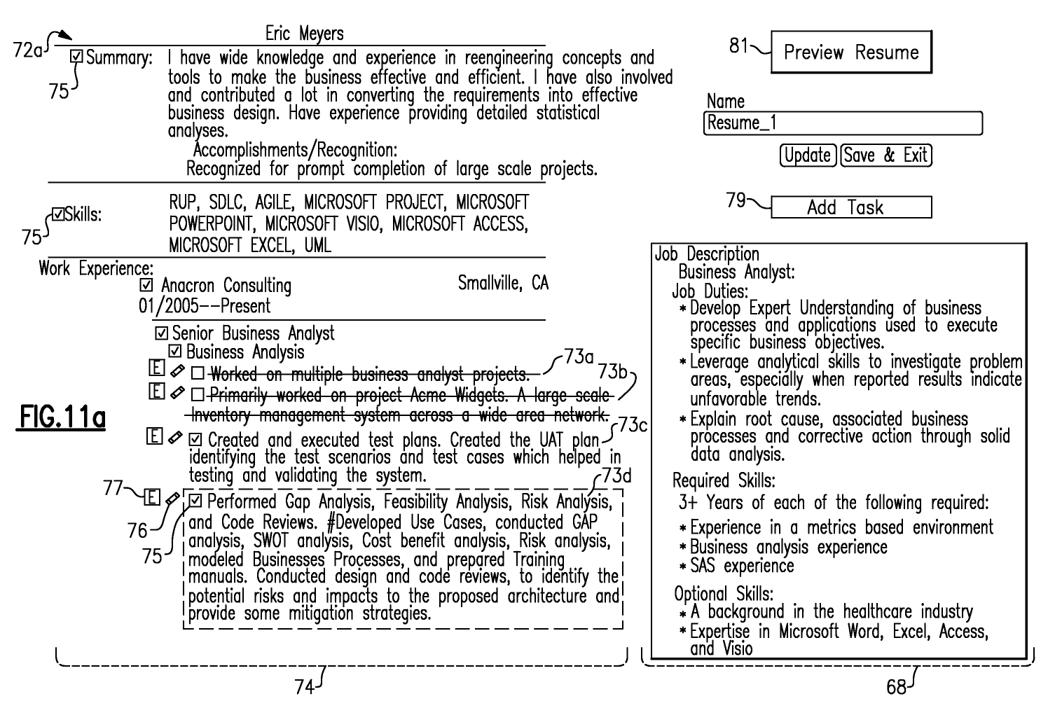

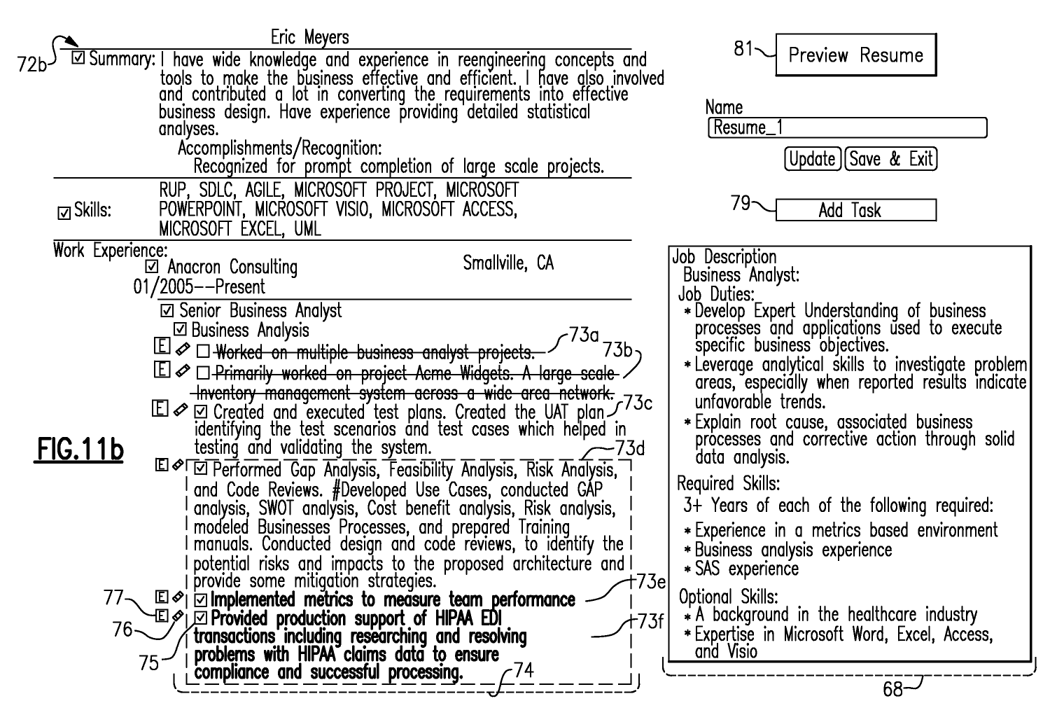

The job description is presented (step 204) alongside a job seeker's employment experience data (step 206) in a resume creation screen 72 (see FIG 11a). The resume creation screen 72a includes check boxes 75, highlight buttons 76, and edit buttons 77 for each of the job seeker's tasks. In one example clicking the highlight button 76 gives a job seeker 34 a highlighter cursor that can be used to highlight some or all of a task.

In this screen 72a, a job seeker 34 can select or deselect their employment experience data 74 (via check boxes 75) to create a resume tailored to the job description. Also, summary information, skills, and entire groups of task data (e.g. “Anacron Consulting” can be selected and deselected via check boxes 75. The job seeker can also edit their existing employment experience data (button 77), can selectively highlight the data (button 76), can add additional tasks (button 79), and can request a resume preview (button 81).

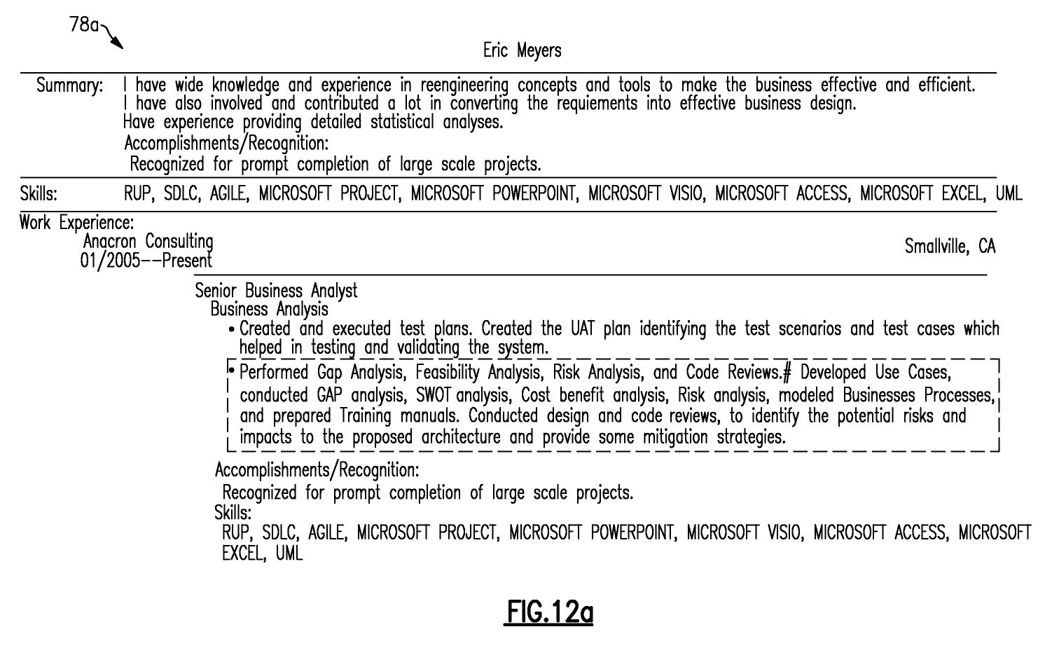

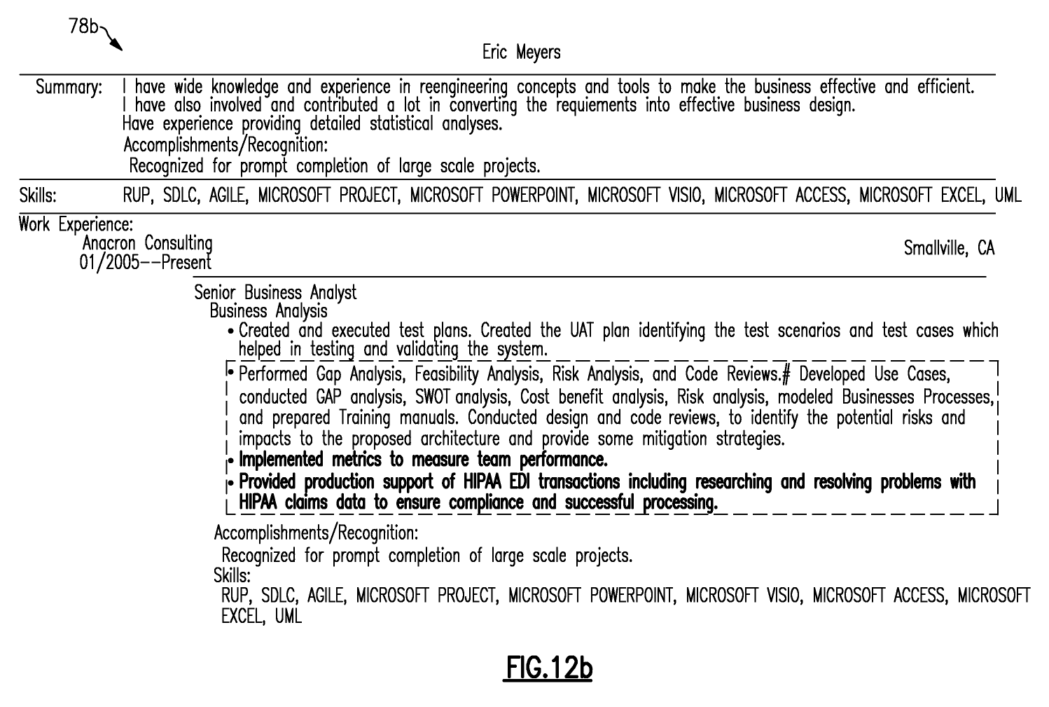

As shown in FIG. 72a, two tasks 73a-b are deselected, two tasks 73c-d are checked, and one task 73d is highlighted (shown by dotted lines). At this point clicking the preview resume button 81 would yield a resume 78a as shown in FIG. 12a. If a job seeker 34 (or a recruiter 38 editing the job seeker's data) were to select the add task button 79 to add tasks 73e-f (indicated in bold), and were to highlight those tasks 73e-f (see FIG. 11b), then selecting the resume preview button 81 would yield a resume 78b as shown in FIG. 12b.

Although highlighted tasks are shown by a dotted line, it is understood that they could be indicated by a color (e.g. yellow) highlighting in the system 30.

The selection of employment data that the job seeker identifies as being relevant to the job description is received (step 208), and a resume is dynamically generated (step 210). In one example, generated resumes are stored in a standardized format within a searchable database in the database 45. The use of a standardized format eliminates the need for employers 36 or recruiters 38 to scan multiple resume formats.

As described above, FIGS. 12a-b illustrate example resumes 78a-b generated in step 210. A job seeker can selectively repeat the steps 204-210 to create multiple resumes for a single job description 66, or for multiple job descriptions 66.

The job seeker can transmit their resume to the employer that provided the job description (step 212) for consideration. Also, the job seeker could add a reference to bolster their employment experience data, as shown in steps 214-220. To add a reference, a selection of employment experience data is received (step 214), and contact information (e.g. an email address) is received for an employment reference that the job seeker believes can confirm the selected employment experience data (step 216). The employment reference is contacted to verify a portion of the job seeker's employment experience data (step 218). The employment reference is confirmed (step 220) in response to receiving verification of the employment experience data from the reference.

Job Placement in VMS System

The system 30 can be adapted for use in a vendor-managed system (“VMS”) for recruiting (see configuration 46b of FIG. 2b). For example, if an employer 36 wished to use a recruiting firm to perform job placements, a recruiter 38 could act as an intermediary between job seekers 34 and the employer 36 in the VMS system.

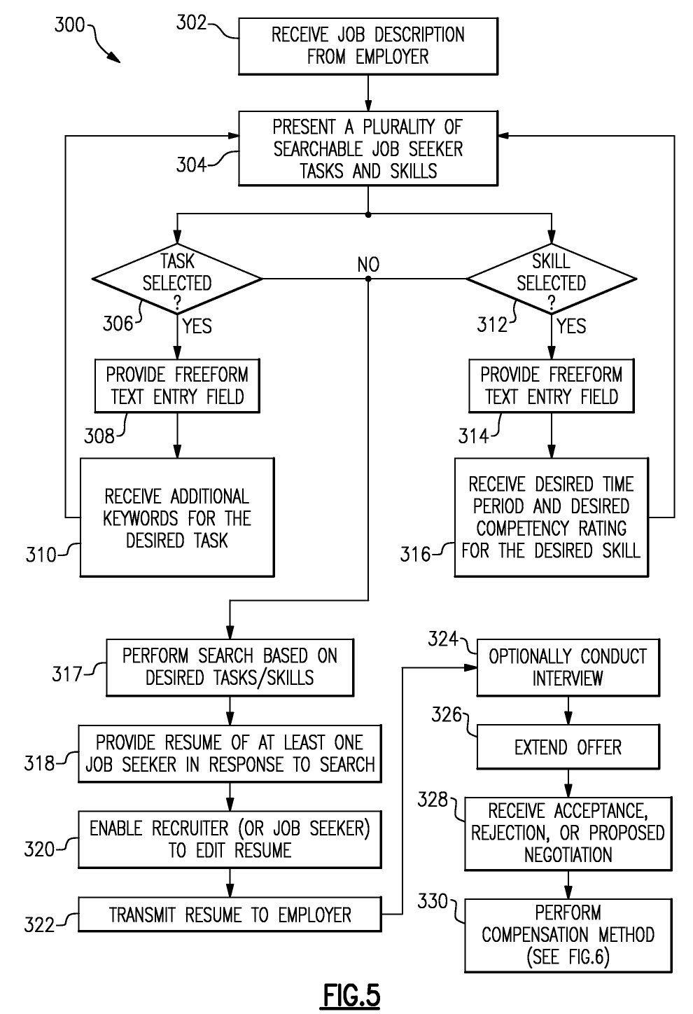

FIG. 5 schematically illustrates a computer-implemented method 300 of performing a job placement. A job description 66 is received from an employer 36 (step 302) (see FIG. 10). Multiple job seeker tasks 54 and skills 56 are then presented to the recruiter 38 (step 304) (see FIGS. 8-9). The recruiter can then select tasks (step 306) and skills (step 312) desired for the job description. In a similar fashion to the method 100, (see FIGS. 3, 7-9), the recruiter can select a task (step 306), and can enter data required for that task 54 for the job description in a freeform text entry field 58 (steps 308-310) (see FIG. 8b). Also, the recruiter can select a skill 56 (step 312), can enter data required for the skill 56 in freeform entry field 60 (step 314), and can select a desired duration of experience 62 and a desired competency rating 64 for the selected skill (steps 314-316). In one example, the freeform entry field 58 is provided (step 308) in response to the task selection (step 306), and the freeform entry field 60 is provided (step 314) in response to the skill selection (step 312).

The system 30 performs a search in response to the desired tasks and skills (step 317), and in response to the search, one or more resumes are provided to the recruiter 38 (step 318). The recruiter 38 can optionally edit the job seeker's resume (step 320), as is commonplace in the recruiting industry, and the resume can be transmitted to the employer (step 322) (see, e.g. resume transmission screen 1012 of FIG. 21). Also, the recruiter 38 could just view the resume, or the recruiter could delete the resume.

In the prior art, searches to find job seekers (or perhaps people who are employed but not necessarily seeking jobs) were performed largely based on title. However, titles can be generic and vague, and as such can yield poor search results. Also, in the prior art if a recruiter conducted a search based upon the keyword such as “Oracle,” then all resumes within the database containing even a single occurrence of the word “Oracle” will result in a match. A match to the keyword of “Oracle” does not mean, however, that a job seeker has recent, working knowledge of Oracle. It simply means that the word appears somewhere on the job seeker's resume, perhaps as result of a class taken years earlier. The end result is that the recruiter 38 or employer 36 may waste large amounts of time and effort contacting the wrong candidate due to inaccurate information and inefficient search tools. By searching for actual job skills and tasks performed (and optionally a time period for a task or a skill), the system 30 provides a superior process for identifying qualified job seekers for a given job description.

Optionally, the recruiter or the employer can conduct an interview with the job seeker (step 324). If the recruiter conducts the interview, the employer could provide pre-recorded questions, or could provide the questions in text or another format, to which the job seeker could respond over the network (e.g. via microphone, webcam, or both). Also, the job seeker 34 could reply by going to an office of the recruiter 38, where the recruiter could record the answers and could post them to the job seeker's profile 86 (see FIG. 16). In one example the job seeker is given the questions and must respond immediately as in a real interview, instead of receiving a list of questions for which the job seeker could prepare rehearsed, less spontaneous answers. The interview could be recorded (audibly, or audibly and visually) and electronically transmitted to the employer. If the employer performs the interview, the interview could also be conducted over the network (e.g. via webcam), and then optionally archived on the server 32. For example, the interview could be stored in a profile 86 for a job seeker 34 (see FIG. 16).

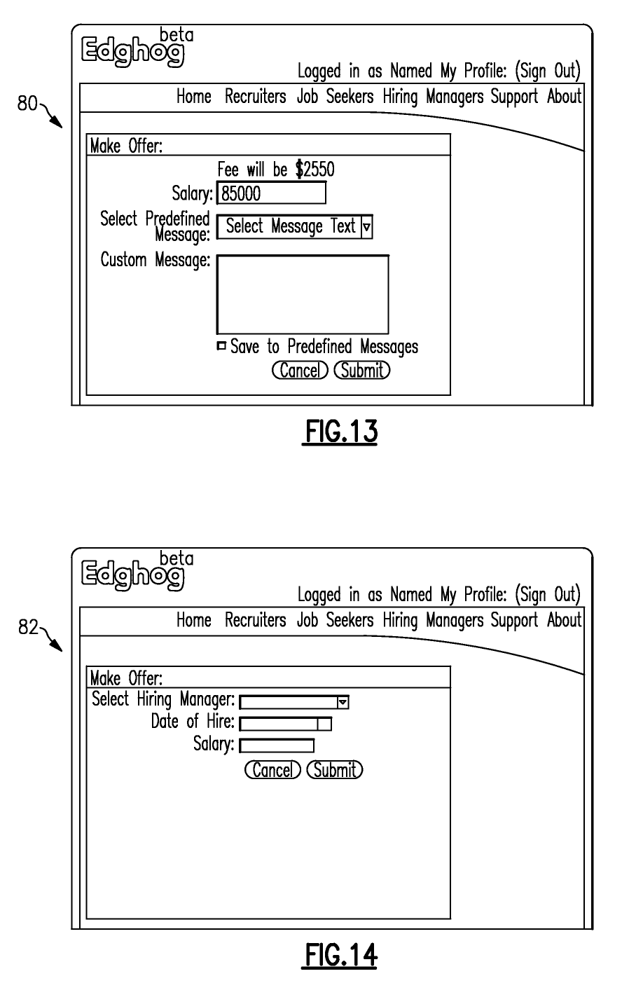

An offer can be extended to the job seeker as the employer sees fit (step 326) (see screen 80 of FIG. 13). Step 326 could include an employer 36 extending an offer directly to a job seeker 34. Also, step 326 could include extending an offer to a recruiter 38, who would then notify the job seeker 34 of the offer (possibly through the system 30). In response to the offer, the job seeker could accept the offer, deny the offer, or negotiate terms of the offer (e.g. salary) electronically through the server (step 328). In one example, to confirm acceptance of the offer, the job seeker visits a job hire confirmation screen (see screen 82 of FIG. 14).

In the marketplace, it is commonplace for a recruiter to earn a portion of an employee's annual salary as a recruiting fee. This creates an incentive for an employer 36 to obtain potential employees from a recruiter 38, and then conceal the eventual hire of one of the potential employees. Because the job seeker 34 will be compensated for obtaining employment through the system 30 (step 330), this provides an incentive for the job seeker 34 to be truthful about obtaining employment, and prevents potential trickery on the behalf of employers 36. The employer 36 could optionally be presented with a job hire confirmation screen also, to prevent job seekers 34 from falsely reporting the attainment of a new job.

Job Placement without Recruiters

In some configurations, job seekers 34 interact directly with employers 36, so the services of a recruiter are not used. This is the case in configuration 46a, and can also be the case in configuration 46b. The method 300 could also be applicable in such a configuration. In step 304 the searchable job seeker tasks and skills would be presented to an employer 36 instead of to a recruiter 38. Step 320 in which a recruiter 38 can edit a resume could be omitted.

Also, while the method 300 has been described to focus primarily on job seeker tasks and skills, it is understood that searches could be performed on other employment experience items, such as education.

Compensation Approval

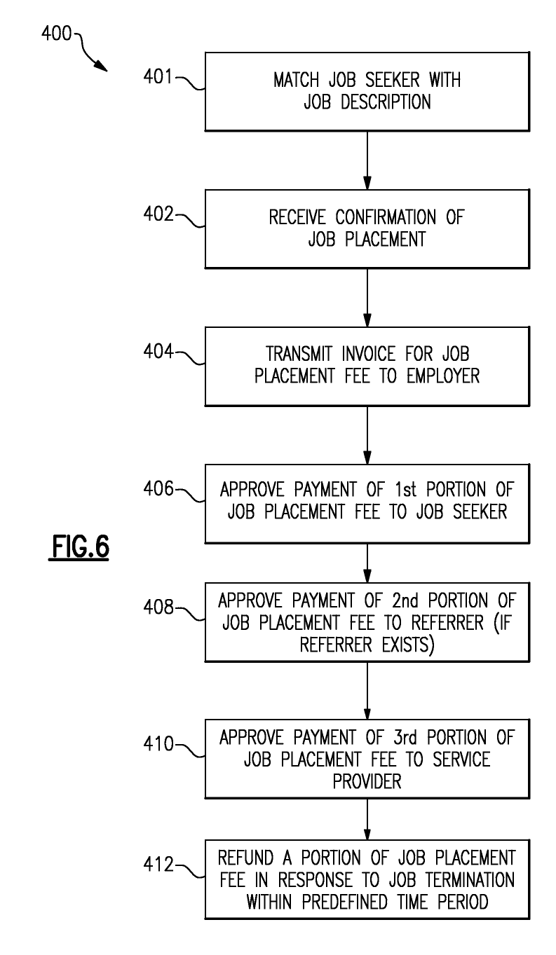

FIG. 6 schematically illustrates a computer-implemented method 400 of approving compensation for a job placement. A job seeker 34 is matched with a job description 46, which could correspond, for example, to the methods 200, 300). Confirmation of a job placement is received (step 402).

An invoice is transmitted to an employer 36 for a job placement fee (step 404). Payment of a first portion of the job placement fee to the job seeker 34 is approved (step 406). Thus, in the system 30, unlike the prior art where recruiting firms 38 are the only ones that get a placement fee for an employee obtaining employment, the job seeker 34 receives an amount of money. This encourages job seekers 34 to use the system 30, and could serve as an incentive to encourage job seekers 34 to enter their employment history data in the system 30.

Payment of a second portion of the job placement fee to a “referrer” is approved (step 408) if the job seeker 34 (“invitee”) that accepted employment (steps 402-404) was invited to the site by another individual (“referrer”). In one example, to invite a job seeker to the site, a referrer would provide contact information (e.g. an email address) for the invitee, and the invitee would receive an email from the system 30. When the invitee clicked a link in the email they would be brought to the system 30, and would be recorded as being invited by the inviting individual. Thus, if there is no referrer, the job seeker 34 receives a larger portion of the money received from the employer 36.

Payment of a third portion of the job placement fee to a service provider is approved (step 410) in response to the service provider hosting the database 45.

In one example, if the job is a salary position the job placement fee corresponds to a one-time payment of a percentage of the salary (e.g. 3%). In one example, if the job is a contract position, the job placement fee corresponds to repeated payments of a portion of a paycheck for a pay period (e.g. bi-weekly, monthly, etc.). In one example the three portions (steps 406-410) each correspond to 33.33% of the job placement fee. Of course, these figures are only exemplary, and other percentages would be possible.

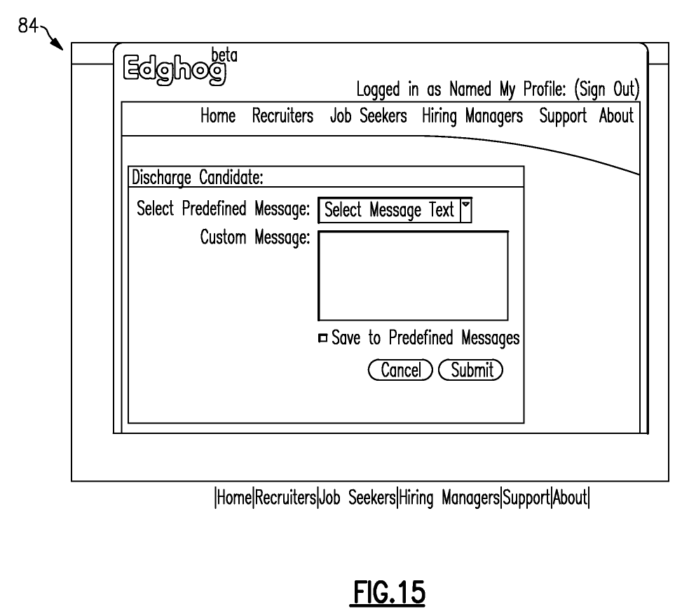

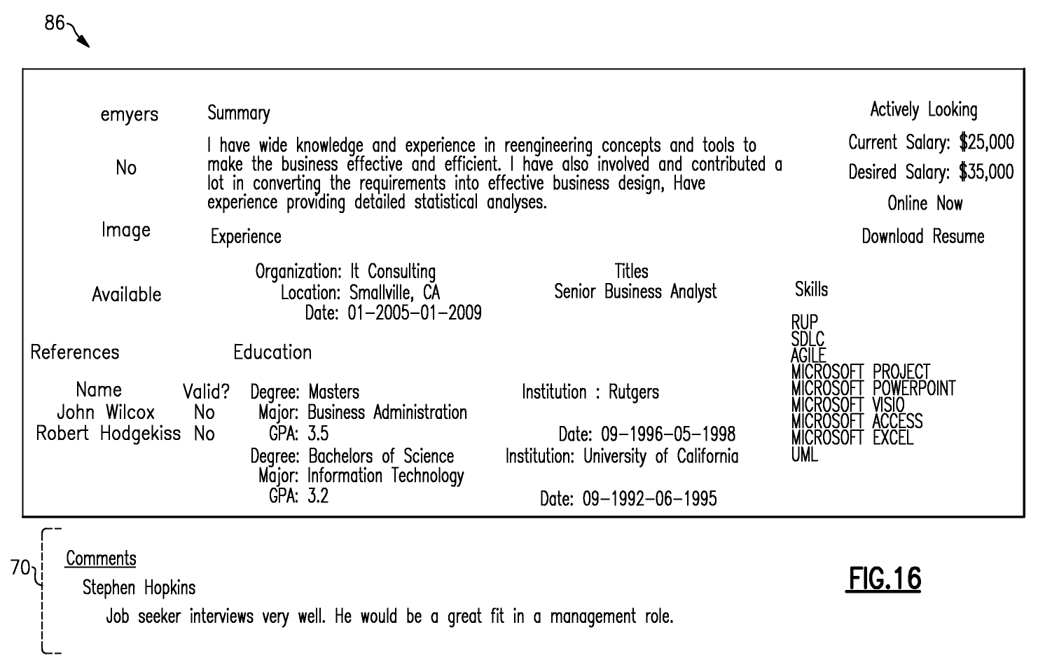

If the job is terminated within a predetermined time period (e.g. 30 days) then at least a portion of the job placement fee can be refunded to the employer (step 412). For example, if the employer fires the employee, or if the employee quits, the employer could contact the system 30 (see screen 84 of FIG. 15), and could receive a refund of part or all of the money received in step 404.

Additional VMS Features

A. Comment/Chat Functionality

If a recruiter is seeking to find a job seeker for a given job, the recruiter may speak to a hiring manager at an employer, and the hiring manager may disclose additional details about the job description (e.g. “Employer requires an undergraduate degree”). Also, a recruiter may have an inquiry for other recruiters (e.g. “Are there any specific educational requirements?”). These inquiries and comments can be posted to a comment area 70 in the job description 66 in the system 30 such that the comments 70 (see FIG. 10) are hidden from the job seeker but are visible to employers 36, recruiters 38, or other VMS participants. In one example, the comment area 70 can act as a “chat” window in which recruiters can discuss a particular job description 66.

Similarly, the “comment” or “chat” functionality could be added to a job seeker profile 86 for particular job seeker so that recruiters could take notes on the job seeker 34. For example, one recruiter 38 may wish to indicate “Job seeker interviews very well. Would be a great fit in a management role.” The system 30 could record this data in comment section 70 of the job seeker profile 86 for other recruiters 38 to see.

Additionally, the chat functionality could be used to enable job seekers 34 to chat with employers 36, recruiters 38, or other job seekers 34, as will be described below (see “Home Screens” section). For example, if an employer 36 saw that a job seeker 34 who matches a job description for which the employer 36 is recruiting is “online now,” the employer 36 could initiate a chat session with that job seeker 34.

B. Pre-Approval Job Seeker Search

Historically, when an employer creates a job description, a hiring manager will draft a description of the job, and will send the job description to a superior for approval. Only when the job description is approved will recruiters receive the job description, and will the recruiters be able to begin searching for qualified individuals for the job.

However, in larger organizations, the approval process can take a long time (e.g. in excess of six weeks). The system 30 gives a hiring manager the option to simultaneously send the job description to recruiters and to their superior at the employer 36. This enables recruiters 38 to begin identifying qualified individuals in advance of the formal approval of the job description. This way, once the job description is finally approved, the employer 36 can have several job seekers identified and ready for interviewing, and possibly even ready for hire.

In one example, multiple individuals at an employer 36 can interact with the system 30. For example, a first hiring manager could approve a job description, which would then make the job description visible to recruiters 38 who could start looking for job seeker 34. Meanwhile, a second hiring manager could review and approve the job description, and then when a third hiring manager could review and approve the job description. The system 30 could be configured to only indicate the job description as approved when approval was received from the third hiring manger, or when approval was received from all three hiring managers, for example.

Home Screens

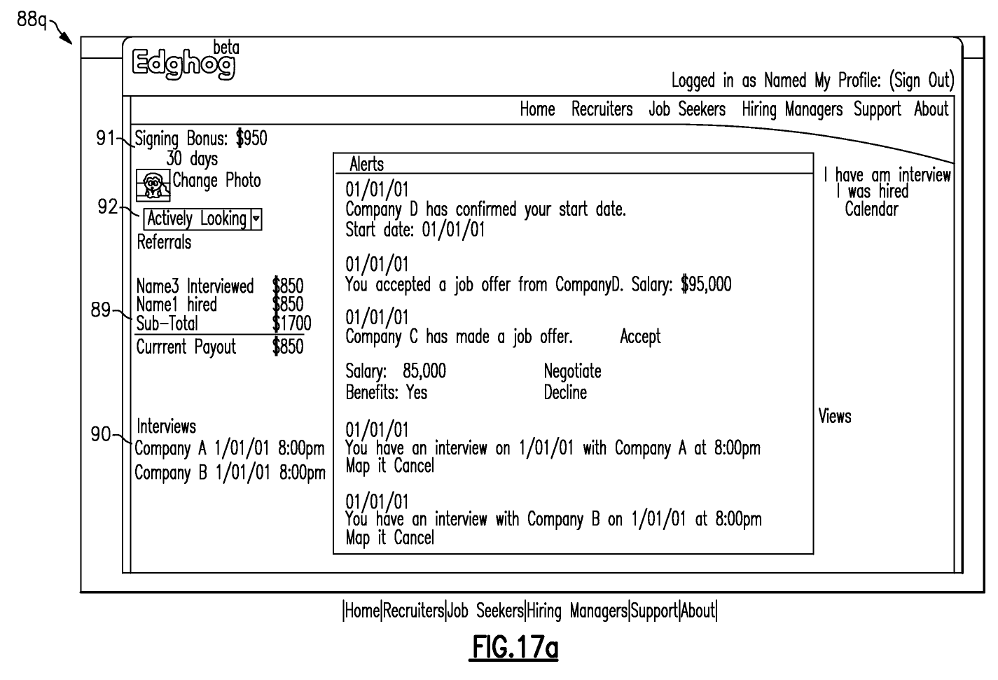

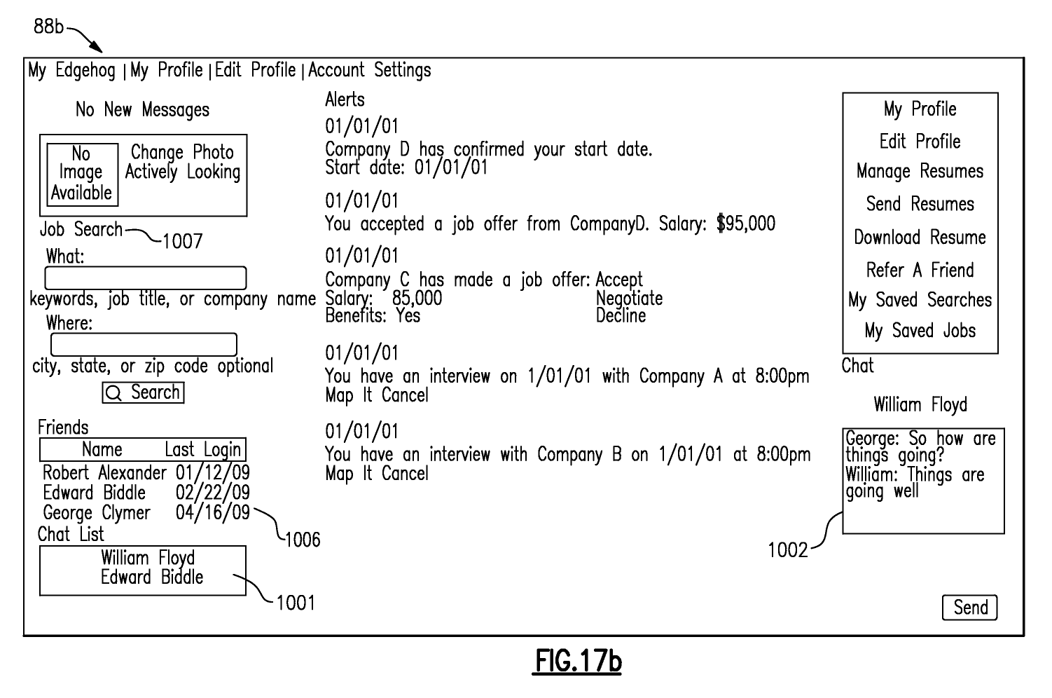

FIG. 17a-b illustrate example job seeker home screens 88a-b in which the job seeker can view activity 89 of people they have referred to the system, can view upcoming interviews 90, can view pending compensation from a job placement 91, and can update their status 92. For example, the job seeker could enter a status 92 such as “Actively Looking” or “Interested in Relocating”, etc. Also, as shown in FIG. 88b, the job seeker can view a list of friends 1006 (e.g. people the invited to the system 30), can view a chat list 1001, and can chat in a chat area 1002. The job seeker 34 could chat with, for example, other job seekers 34, employers 36, or recruiters 38.

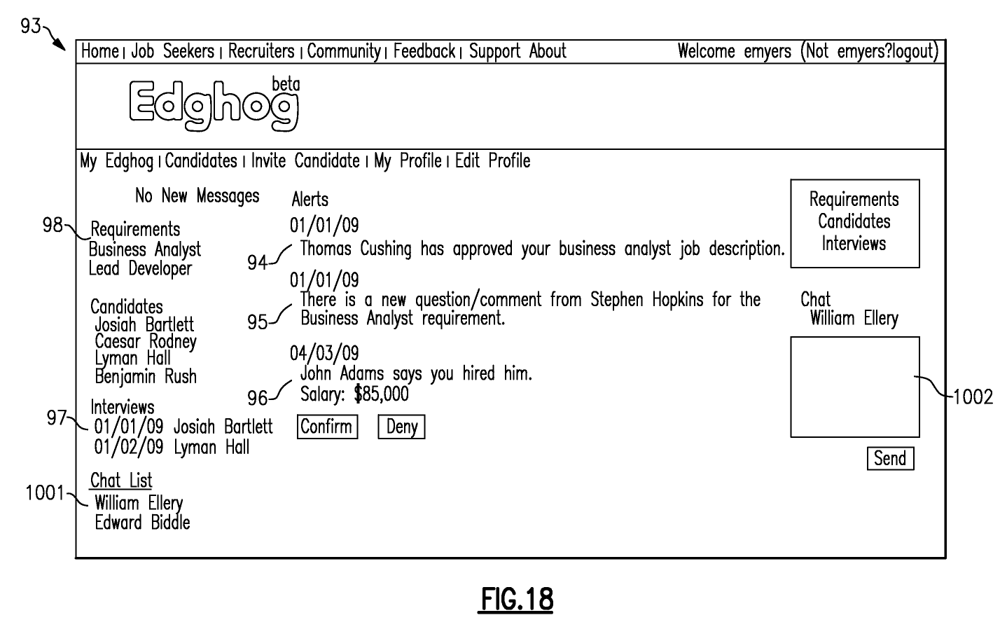

FIG. 18 illustrates an example employer home screen 93 in which the employer can view the status of pending job description approval 94, can view questions from recruiters regarding job descriptions 95, can confirm/deny hiring 96, can view upcoming interviews 97, can view outstanding job descriptions 98, can view a chat list 1001, can chat in a chat area 1002, etc. Although the example question 95 is regarding a job description, it is understood that the questions could correspond to any topic about which a recruiter 38 and an employer 36 wished to communicate. The employer 36 could chat with, for example, job seekers 34, recruiters 38, other employers 36, or other individuals working in the same Human Resources department at a single employer 36.

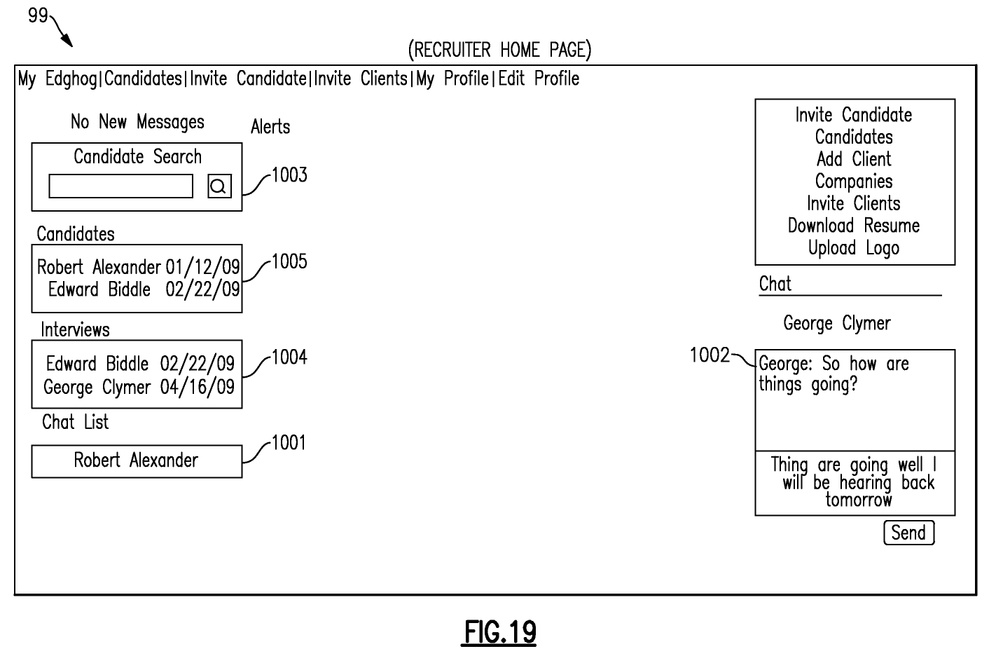

FIG. 19 illustrates an example recruiter home page 99 that includes a chat list 1001, a chat area 1002, a candidate search 1003, a list of interviews 1004, and a list of candidates.

Third Party Job Seekers and Job Descriptions

As discussed above, the system 30 can be configured to interface with third party job placement systems (e.g. www.indeed.com, monster.com, careerbuilder.com, etc.), so that job seekers 34 can view jobs outside of the system 30. Similarly, employers 36 or recruiters 38 would be able to view candidates outside of the system 30. This can increase exposure for the system 30. For example, if a job seeker 34 found a job through the integration of the system 30 with www.indeed.com, the employer using www.indeed.com could get a notification that a job seeker 34 in the system 30 wishes to share their employment history data. In response, the employer may decide to join the system 30. Similarly, this configuration could encourage job seekers to join the system 30, as the system 30 could act as a “one stop shopping” location for job seekers.

Notification

Throughout the system 30 it can be useful at times to notify job seekers 34, employers 36, or recruiters 38 of various actions. For example, it could be useful for a recruiter 38 to be notified that a job description 66 has been approved. Or it could be useful to notify a job seeker 34 that an employer 36 would like to interview the job seeker 34. Some example “alerts” are shown in FIGS. 17a-b and FIG. 18. In one example the notification includes an email message, which may be viewable either in a mail account external to the system 30, or in a mail account viewable only by logging on to the server 32, for example. In one example the notification includes an SMS text message.

Credibility Ranking

In one example the job seekers 34, employers 36, and recruiters 38 would be able to rate each other as part of a feedback or credibility ranking functionality. This, in turn, could affect search results, so that if two equally qualified job seekers were found from a recruiter 38 search, the job seeker with a higher credibility ranking would be listed first.

In one example a party's credibility ranking could be affected by the parties they are associated with. For example, if an employer 36 employs job seekers 34 with high credibility rankings then the credibility ranking of the employer 36 could increase. In one example if the references for a job seeker 34 verified the job seeker's claims (as described above) the credibility ranking of the job seeker would increase.

Transition Between Job Offer and Job Placement

Once a job seeker 34 interviews with an employer 36, several weeks may transpire before the employer 36 decides to extend a job offer to the job seeker 34. During this interim time period the job seeker 34 may receive an interview or job offer from another employer 36. In one example, the system 30 enables job seekers 34 and recruiters 38 to share data from a job seeker profile 86 or home screen 88 (see, e.g. FIGS. 16, 17a-b) with an employer 36. For example, a job seeker's upcoming interviews, offers, status, etc. could be shared with the employer 36.

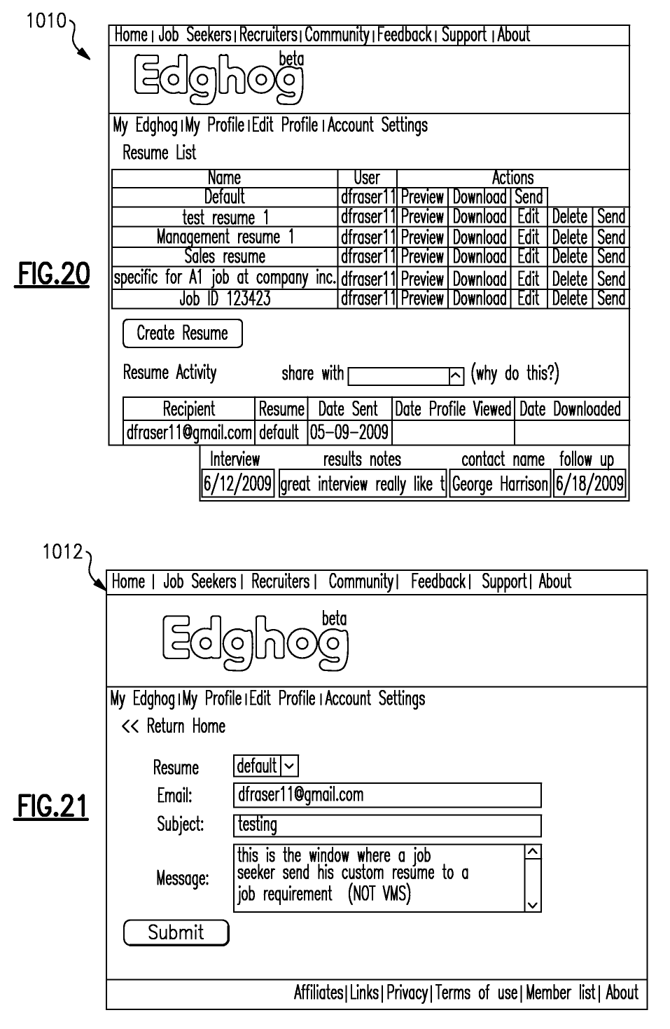

FIG. 20 illustrates an example resume activity screen 1010. The data on this screen (e.g. “Resume Activity”) could be summarized for an employer. For example, an employer could be told “Job seeker's resume went out to 8 companies; Job seeker has five interviews lined up.” This information sharing helps to keep employers 36 informed during this interim time period between interview and offer, so that an employer 36 has a better chance of avoiding the loss of a qualified job seeker to another employer. In one example the employer names are hidden between employers, so that an employer is only notified that a job seeker has an upcoming interview (without learning who the interview is with).

Tiered Recruiting Hierarchy

As shown in FIG. 1, a plurality of recruiters 38 can interact with the system. However, it is also possible for there to be a hierarchy of recruiters 38. In one example a first tier of recruiters corresponds to a service providing recruiting firm that hosts the server 32 and maintains the system, and a second tier of recruiters corresponds to another recruiting firm that is permitted to use the system 30.

Although multiple embodiments of this invention has been disclosed, a worker of ordinary skill in this art would recognize that certain modifications would come within the scope of this invention. For that reason, the following claims should be studied to determine the true scope and content of this invention. Also, alphanumeric identifiers on method steps are for convenient reference in dependent claims and do not signify a required sequence of performance unless otherwise indicated in the claims

What is claimed is:

1. A computer-implemented method of recording employment history of a job seeker, comprising:
receiving at least one employment experience selection from a job seeker;
presenting to the job seeker over a network a plurality of skills and tasks related to the at least one employment experience selection;
asking the job seeker to provide a time period corresponding to an amount of time that the job seeker has used a selected skill;
asking the job seeker to select one of a plurality of predefined competency ratings for the selected skill;
receiving a time period and competency rating for the selected skill;
providing a freeform text entry field for the job seeker to provide information about how the job seeker has performed a selected task; and
receiving over the network from the freeform text entry field a description of how the job seeker has performed the selected task; and
storing in a database on a server the at least one employment experience selection, the selected skill and related skill data received from the job seeker, and the selected task and related task data received from the job seeker.

2. The method of claim 1, further comprising:
providing a freeform text entry field for the job seeker to provide information about how the job seeker has performed the selected skill; and
receiving over the network from the freeform text entry field a description of how the job seeker has performed the selected task; and
storing the freeform text entry data about the selected task received from the job seeker in the database on the server.

3. The method of claim 1, wherein said step of providing a freeform text entry field for the job seeker to provide additional information about a selected task is performed in response to the job seeker selecting the task.

4. A computer-implemented method of recording a job description, comprising:
receiving at least one employment experience selection from an employer;
presenting to the employer over a network a plurality of skills and tasks related to the at least one employment experience selection;
asking the employer to provide a time period corresponding to an amount of time that that the employer wishes a job seeker to have used a selected skill;
asking the employer to select one of a plurality of predefined competency ratings corresponding to a competency that the employer wishes a job seeker to have for the selected skill;
receiving a time period and competency rating for the selected skill;
providing a freeform text entry field for the employer to provide information about a selected task the employer wishes a job seeker to have performed; and
receiving over the network from the freeform text entry field a description of the task that the employer wishes a job seeker to have performed; and
storing in a database on a server the at least one employment experience selection, the selected skill and related skill data received from the employer, and the selected task and related task data received from the employer as a job description.

5. A computer-implemented method of dynamically generating a resume, comprising:
storing employment experience data received over a network from a job seeker;
transmitting a job description having a plurality of associated job characteristics to the job seeker;
providing a menu in which the job seeker can select or deselect the employment experience data;
receiving a selection of employment experience data from the job seeker identified as being relevant to the job characteristics; and
dynamically generating a resume on a server in response to the selection of employment experience data.

6. The method of claim 5, wherein said step of providing a menu in which the job seeker can select or deselect the employment experience data includes displaying the employment experience data in a first portion of a display and displaying the job description on a second portion of the display.

7. The method of claim 5, further comprising:
transmitting the dynamically generated resume to an employer associated with the job description.

8. The method of claim 5, further comprising:
notifying at least one of the job seeker, the employer, and the recruiter of a job event via email, text message, or both.

9. The method of claim 5, wherein the job event corresponds to job interview, a job offer, a job offer rejection, a job offer acceptance, a proposed salary negotiation, a job termination, a resume transmittal, a received job description, or an invitee registration.

10. The method of claim 5, wherein the selection of employment experience data from the job seeker may include a selection of highlighted text, and wherein the dynamically generated resume highlights the selection of highlighted text.

11. The method of claim 5, wherein said steps of receiving a selection of employment experience data and dynamically generating a resume may be selectively repeated for a plurality of job descriptions, so that multiple resumes may be stored on the server for a single job seeker.

12. The method of claim 5, wherein either the job seeker or a recruiter may edit the dynamically generated resume.

13. The method of claim 5, wherein the job characteristics include at least one of job-related tasks, skills, responsibilities and qualifications.

14. The method of claim 5, further comprising:
receiving contact information for an employment reference from the job seeker;
contacting the employment reference to verify a portion of the employment experience data selection; and
indicating the employment reference as a confirmed reference in response to receiving verification of the portion of employment experience data from the reference.

15. A computer-implemented method of performing a job placement, comprising:
receiving on a server over a network a job description from an employer, wherein the job description corresponds to a job for which the employer is seeking an employee;
presenting a plurality of searchable job seeker tasks and skills;
receiving a selection of desired tasks and skills corresponding to the job description;
searching a database of job seeker employment experience data in response to the selection of desired tasks and skills;
providing a resume of at least one job seeker in response to the search; and
transmitting the resume to the employer, wherein the job description may be received and the resume may be transmitted prior to the job description being formerly approved by a manager at the employer.

16. The method of claim 15, wherein the job description is received from a third party job placement system.

17. The method of claim 15, further comprising:
receiving over the network additional information regarding the job description from a first recruiter, such that a second recruiter can refer to the additional information when seeking to find an appropriate job seeker for the job.

18. The method of claim 15, wherein the selection of desired tasks and skills may include a duration of experience and a competency rating for a selected skill.

19. The method of claim 15, further comprising:
receiving a plurality of resume changes from the recruiter.

20. The method of claim 15, further comprising:
conducting an interview over the network from the server, in which vocal responses to live or pre-recorded questions are received from the job seeker.

21. The method of claim 20, wherein the vocal responses are received as part of a video recording.

22. The method of claim 20, further comprising:
transmitting the vocal responses are to the employer.

23. The method of claim 20, further comprising:
storing the vocal responses in a job seeker profile; and
permitting at least one of the recruiter or the employer to access the job seeker profile and playback the vocal responses.

24. The method of claim 15, wherein said step of transmitting the resume to the employer from the server may be selectively repeated so that a plurality of resumes is transmitted to the employer.

25. The method of claim 15, further comprising:
extending a job offer to the job seeker from the server over the network; and
receiving an acceptance or rejection of the job offer over the network.

26. The method of claim 15, further comprising:
facilitating an electronic chat communication between a first party, and a second party, wherein each of the first party and the second party correspond to at least one of a job seeker, an employer, and a recruiter.

27. A method of approving compensation for a job placement, comprising:
A) matching a job seeker out of a database of job seekers with a job description out of a database of job descriptions, wherein the job description is associated with an employer;
B) receiving confirmation of a job placement between the job seeker and the employer;
C) transmitting an invoice for a job placement fee to the employer in response to step (A); and
D) approving payment of a first portion of the job placement fee to the job seeker.

28. The method of claim 27, further comprising:
E) associating the job seeker with a referrer; and
F) approving payment of a second portion of the job placement fee to the referrer in response to step (B) and in response to the referrer having invited the job seeker to enter employment history data in the database of job seekers.

29. The method of claim 28, further comprising:
G) approving payment of a third portion of the job placement fee to a service provider, in response to the service providing hosting at least one of the database of job seekers and the database of job descriptions.

30. The method of claim 27, wherein the job placement fee is a one time payment corresponding to a percentage of a salary associated with job if the job is a salaried position, and wherein the job placement fee is a repeated payment corresponding to a portion of a paycheck if the job is a contract position.

31. The method of claim 27, further comprising:
refunding at least a portion of the job placement fee to the employer in response to the job seeker starting the job on a first date, and the employer or the job seeker terminating the employment on a second date that is within a certain number of days after the first date.

32. A computer-implemented job placement system, comprising:
a computer including memory and a processor, wherein the computer is programmed to receive information relating to job descriptions and job seekers;
an employment database stored in the memory, the employment database comprising:
at least one the job description corresponding to a job for which an employer is seeking an employee;
an employment experience selection from a job seeker;
an explanation of how a job seeker has performed at least one task and at least one skill associated with the employment experience selection;
at least one competency rating indicating the job seeker's level of expertise for the at least one skill; and
at least one duration of experience indicating a duration of time the job seeker has possessed the at least one skill; and
a resume software module operable to dynamically generate a resume on the server in response to the employment experience data, at least one explanation, at least one competency rating, and at least one duration of experience.
